(19) United States
(12) Patent Application Publication
(10) Pub. No.: US 2019/0325862 A1
(43) Pub. Date: Oct. 24, 2019

(54) NEURAL NETWORK FOR CONTINUOUS SPEECH SEGMENTATION AND RECOGNITION

(71) Applicant: Eta Compute, Inc., Westlake Village, CA (US)

(72) Inventors: Hari Shankar, Westlake Village, CA (US); Narayan Srinivasa, Portland, OR (US); Gopal Raghavan, Thousand Oaks, CA (US); Chao Xu, Thousand Oaks, CA (US)

(21) Appl. No.: 16/392,434

(22) Filed: Apr. 23, 2019

Related U.S. Application Data
(60) Provisional application No. 62/661,458, filed on Apr. 23, 2018.

(51) Int. Cl. G10L 15/16; G10L 15/04; G10L 15/08; G10L 15/06

(52) U.S. Cl. CPC G10L 15/16; G10L 15/04; G10L 2015/088; G10L 15/063; G10L 15/08

(57) ABSTRACT

Continuous automatic speech segmentation and recognition systems and methods are described that include a detector coupled to a neural network. The neural network performs speech recognition processing on feature vectors sequentially extracted from an audio data stream to attempt to recognize a word from a set of words of a predetermined vocabulary. The neural network has word neural paths to each output a respective word output signal to the detector for each of the set of words. The neural network also has a trigger neural path to output a trigger signal to the detector to control when the detector reviews the word output signals to recognize the word.

### RELATED APPLICATION INFORMATION

This patent claims priority from provisional patent application 62/661,458, filed Apr. 23, 2018, titled “A NEURAL NETWORK FOR CONTINUOUS SPEECH SEGMENTATION AND RECOGNITION” which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to automatic speech recognition using neural networks.

### Description of the Related Art

Automatic Speech Recognition (ASR) has historically been a driving force behind many machine learning (ML) techniques, including the mathematical models, neural networks and learning used. Artificial neural networks (ANN) are computing systems inspired by the biological networks of animal brains. An artificial neural network is based on a collection of connected units or nodes called artificial neurons, which have similar function to the neurons in a biological brain. Artificial neural networks have been used on a variety of tasks, including computer vision, speech recognition, machine translation, social network filtering, game playing, and medical diagnosis. Within this patent, the terms “neural network” and “neuron” refer to artificial networks and artificial neurons, respectively.

Within a neural network, each neuron typically has multiple inputs and a single output that is a function of those inputs. Most commonly, the output of each neuron is a function of a weighted sum of its inputs, where the weights applied to each input are set or “learned” to allow the neural network to perform some desired function. Neurons may be broadly divided into two categories based on whether or not the neuron stores its “state”, which is to say stores one or more previous values of its output.

FIG. 1A is a schematic representation of a neuron 110 that does not store its state. The operation of the neuron 110 is governed by equation 001.

$$y = Φ ( {\sum }_{j = 1}^{n} {x}_{j} {w}_{j} ) \qquad 001$$

The neuron 110 has n inputs (where n is an integer greater than or equal to one) x₁ to xₙ. A corresponding weight w₁ to wₙ is associated with each input. The output y of the neuron 110 is a function Φ of a weighted sum of the inputs, which is to say the sum of all of the inputs multiplied by their respective weights. Each input may be an analog or binary value. Each weight may be a fractional or whole number. The function Φ may be a linear function or, more typically, a nonlinear function such as a step function, a rectification function, a sigmoid function, or other nonlinear function. The output y may be a binary or analog value. The output y is a function of the present values of the inputs x₁ to xₙ, without dependence on previous values of the inputs or the output.

FIG. 1B is a schematic representation of a neuron 120 that stores its previous output value or state. The operation of the neuron 120 occurs in discrete time intervals or frames. The operation of the neuron in frame k is governed by equation 002.

$${y}_{k} = Φ ( {\sum }_{j = 1}^{n} {x}_{j , k} {w}_{j} + {fy}_{k - 1} ) \qquad 002$$

The neuron 120 has n inputs (where n is an integer greater or equal to than one), where x_{1,k} to x_{n,k} are the values of the inputs at frame k. A corresponding weight w₁ to wₙ is associated with each input. The neuron 120 has an output yₖ (the output value at frame k) and stores a previous state yₖ₋₁ (the output value at previous frame k−1). In this example, the stored state yₖ₋₁ is used as an input to the neuron 120. The output yₖ is a function Φ of a weighted sum of the inputs at time k plus yₖ₋₁ multiplied by a feedback weight f. Each input x_{1,k} to x_{n,k}, the output yₖ, and the stored state yₖ₋₁ may be, during any frame, an analog or binary value. Each weight w and f may be a fractional or whole number. The function Φ may be a linear function or, more typically, a nonlinear function as previously described.

The stored state of a neuron is not necessarily returned as an input to the same neuron, and may be provided as an input to other neurons. A neuron may store more than one previous state. Any or all of the stored states may be input to the same neuron or other neurons within a neural network.

Neurons such as the neurons 110 and 120 can be implemented as hardware circuits. More commonly, particularly for neural nets comprising a large number of neurons, neurons are implemented by software executed by a processor. In this case the processor calculates the output or state of every neuron using the appropriate equation for each neuron.

Neurons that do not store their state will be referred to herein as “non-state-maintaining” (NSM) and neurons that do store their state will be referred to herein as “state-maintaining” (SM). Neural networks that incorporate at least some SM neurons will be referred to herein as SM networks. Examples of SM neural networks include recurrent neural networks, long short-term memory networks, echo state networks (ESN), and time-delay neural networks. Neural networks incorporating only NSM neurons will be referred to herein as NSM networks.

### BRIEF DESCRIPTION OF THE DRAWINGS

FIG. 1A is a schematic representation of a non-state-maintaining neuron.

FIG. 1B is a schematic representation of a state-maintaining neuron.

FIG. 2 is a functional block diagram of an exemplary conventional speech recognition system.

FIG. 3 is a functional block diagram of a continuous automatic speech recognition (ASR) system using a trigger neural path to control when a detector reviews the outputs of a neural network.

FIG. 4 is a functional block diagram of the improved continuous ASR system of FIG. 3 showing details of detector.

FIG. 5 is a block diagram of a continuous ASR system using a trigger neural path to control when a detector reviews the outputs of a neural network.

FIG. 6 is a flow chart of the operation of a continuous ASR system.

FIG. 7 is a block and timing diagram showing a training system for training a model of a continuous ASR system that may be used for improved speech segmentation and recognition.

FIG. 8 is a block and timing diagram related to using a trained model of a continuous ASR system for improved continuous speech segmentation and recognition.

Throughout this description, elements appearing in figures are assigned three- or four-digit reference designators, where the two least significant digits are specific to the element and the most significant digit(s) is(are) the figure number where the element is introduced. An element that is not described in conjunction with a figure may be presumed to have the same characteristics and function as a previously-described element having the same reference designator.

### DETAILED DESCRIPTION

There is a desire to improve speech segmentation and recognition in automatic speech recognition (ASR). For example, there is a need for a continuous automatic speech recognition (ASR) system that can recognize a limited vocabulary while minimizing power consumption. The continuous ASR system needs to be able to continuously identify recognizable words (e.g., the limited vocabulary) in an audio data stream that that may contain numerous other spoken words. The continuous ASR system may be powered on, receiving audio data, and performing speech recognition over an extended period of time. Preferably, the ASR system will recognize words within its limited vocabulary without wasting power processing unwanted words or sounds. Additionally, the ASR system will preferably recognize words within its vocabulary in a continuous audio stream without having to be turned on or prompted by a user just before a user speaks a word or command. Such an ASR system may be applied, for example, in game controllers, remote controls for entertainment systems, and other portable devices with limited battery capacity. Descriptions herein include embodiments of a neural network for continuous speech segmentation and recognition, such as in an ASR system.

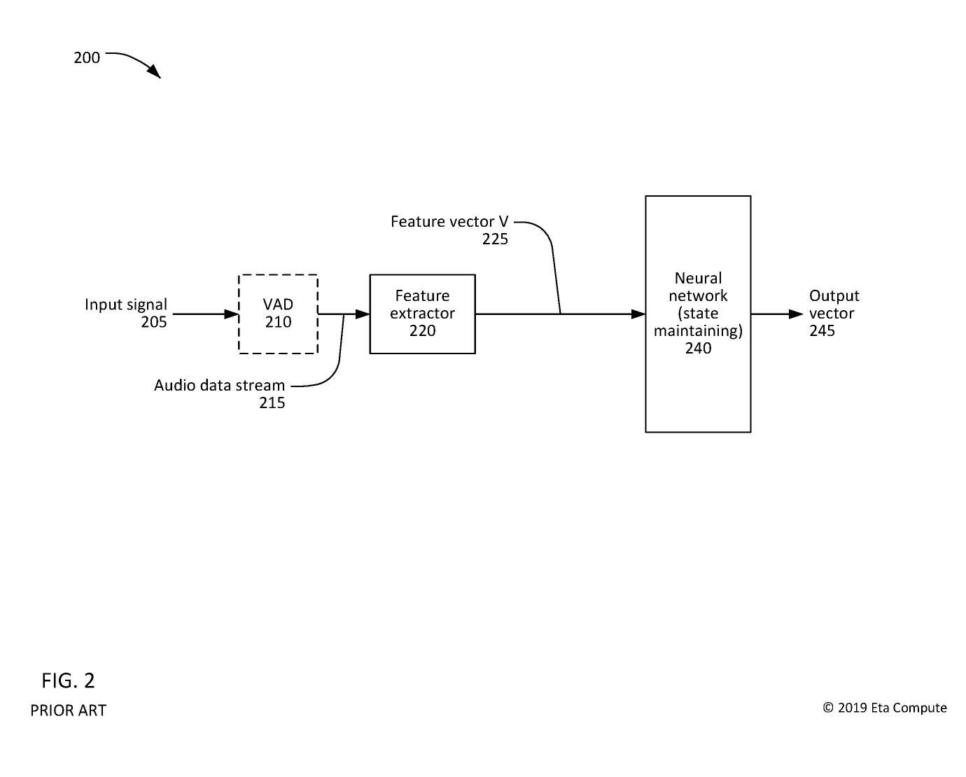

FIG. 2 is a functional block diagram of a representative conventional continuous ASR system 200 using a neural network. Numerous different ASR system architectures using neural networks have been developed. The ASR system 200 is a simplified example provided to illustrate some of the problems with some conventional systems. The ASR system 200 includes an optional voice activity detector (VAD) 210, an optional feature extractor 220 and an SM neural network 240. The VAD 210 and the feature extractor 220 are optional such as when the audio input signal 205 is processed differently to create digital or analog inputs for input to the network 240.

The input signal 205 to the ASR system 200 may be an analog signal or a time-varying digital value. In either case, the input signal 205 is typically derived from a microphone. The input data 205 may be audio inputs such as a verbal or other (e.g., speaker output) audio signals, each having an utterance of a word or term. The input signal 205 may or may not include one word of set of words W₁-W_{X} of a limited vocabulary.

The output of the ASR system 200 is an output vector 245, which is a list of probabilities that the input signal 205 contains respective words. For example, assume the ASR system 200 has a vocabulary of twenty words. In this case, the output vector 245 may have twenty elements, each of which indicate the probability that the input signal contains or contained the corresponding word from the vocabulary. Each of these elements may be converted to a binary value (e.g. “1”=the word is present; “0”=the word is not present) by comparing the probability to a threshold value. When two or more different words are considered present in the audio data stream at the same time, additional processing (not shown) may be performed to select a single word from the vocabulary. For example, when multiple words are considered present, a particular word may be selected based on the context established by previously detected words.

The VAD 210, when present, receives the input signal 205 and determines whether or not the input signal 205 contains, or is likely to contain, the sound of a human voice. For example, the VAD 210 may simply monitor the power of the input signal 205 and determine that speech activity is likely when the power exceeds a threshold value. The VAD 210 may include a bandpass filter and determine that voice activity is likely when the power within a limited frequency range (representative of human voices) exceeds a threshold value. The VAD may detect speech activity in some other manner. When the input signal 205 is a time-varying digital value, the VAD may contain digital circuitry or a digital processor to detect speech activity. When the input signal 205 is an analog signal, and the VAD may contain analog circuitry to detect speech activity. In this case, the input signal 205 may be digitized after the VAD such that a time-varying digital audio data stream 215 is provided to the feature extractor 220. When speech or speech activity is not detected, the other elements of the ASR system 200 may be held in a low power or quiescent state in which they do not process the input signal or perform speech recognition processing. When speech activity is detected (or when the VAD 210 is not present), the elements of the ASR system 200 process the input signal 205 as described in the following paragraphs.

When the VAD 210 indicates the input signal contains speech, the feature detector 220 divides the input signal into discrete or overlapping time slices commonly called “frames”. For example, European Telecommunications Standards Institute standard ES 201 108 covers feature extraction for voice recognition systems used in telephones. This standard defines frame lengths of 23.3 milliseconds and 25 milliseconds, depending on sampling rate. Each frame encompasses 200 to 400 digital signal samples. In all cases, the frame offset interval, which is the time interval between the start of the current frame and the start of the previous frame, is 10 milliseconds, such that successive frames overlap in time. Other schemes for dividing a voice signal into frames may be used.

The feature extractor 220, when present, converts each frame into a corresponding feature vector V 225. Each feature vector contains information that represents, or essentially summarizes, the signal content during the corresponding time slice. A feature extraction technique commonly used in speech recognition systems is to calculate mel-frequency cepstral coefficients (MFCCs) for each frame. To calculate MFCCs, the feature extractor performs a windowed Fourier transform to provide a power spectrum of the input signal during the frame. The windowed Fourier transform transforms the frame of the input signal 205 from a time domain representation into a frequency domain representation. The power spectrum is mapped onto a set of non-uniformly spaced frequency bands (the “mel frequency scale”) and the log of the signal power within each frequency band is calculated. The MFCCs are then determined by taking a discrete cosine transform of the list of log powers. The feature extractor may extract other features of the input signal in addition to, or instead of, the MFCCs. For example, ES 201 108 defines a 14-element speech feature vector including 13 MFCCs and a log power value. Fourteen elements may be a minimum, or nearly a minimum, practicable length for a speech feature vector and other feature extractions schemes may extract as many as 32 elements per frame.

Each feature vector contains a representation of the input signal during a corresponding time frame. Under the ES 201 108 standard, the feature extractor divides each second of speech into 100 frames represented by 100 feature vectors, which may be typical of current speech recognition systems. However, a speech recognition system may generate fewer than or more than 100 feature vectors per second. An average rate for speech is four or five syllables per second. Thus, the duration of a single spoken word may range from about 0.20 second to over 1 second. Assuming the feature extractor 220 generates 100 feature vectors per second, a single spoken word may be captured in about 20 to over 100 consecutive feature vectors.

When an SM neural network is used to perform speech recognition processing, the output of the neural network depends on the present inputs to the network with consideration of the previous time history of those inputs. Thus, for an SM neural network to recognize a word captured in a series of feature vectors, a significant portion of the feature vectors that capture the word and a consideration of the prior input usually should be available to the SM neural network concurrently.

The ASR system 200 includes the neural network 240 to perform speech recognition processing of a current frame of the consecutive feature vectors from the feature extractor 220. A new feature vector is processed by the neural network 240 every frame offset interval. That is, the feature vectors of each frame will be sequentially available as inputs to the neural network 240.

The neural network 240 performs speech recognition processing of the content of the consecutive feature vectors of feature vectors V 225. The neural network 240 may be a “deep” neural network divided into multiple ranks of neurons including an input rank of neurons that receives feature vectors from the vector memory 225 an output rank that generates the output vector 245, and one or more intermediate or “hidden” ranks. For example, the neural network 240 may be an SM neural network such as a recurrent neural network, a long short-term memory network, an echo state network (ESN) or a time-delay neural network similar to those types currently used for speech recognition. The number of hidden ranks and the number of neurons per rank in the neural network 240 depend, to some extent, on the number of words in the set of words of the vocabulary to be recognized. Typically, each input to the neural network 240 receives one feature vector for a frame from the extractor 220. The neural network 240 may be designed and trained using known methods.

The functional elements of the voice recognition system 200 may be implemented in hardware or implemented by a combination of hardware, software, and firmware. The feature extractor 220, and/or the neural network may be implemented in hardware. Some or all of the functions of the feature extractor 220 and the neural network may be implemented by software executed on one or more processors. The one or more processors may be or include microprocessors, graphics processors, digital signal processors, and other types of processors. The same or different processors may be used to implement the various functions of the speech recognition system 200.

In the speech recognition system 200, the neural network 240 performs speech recognition processing on the content of the vector memory every frame offset interval (or every frame offset interval when the optional VAD indicates the input potentially contains voice activity). However, even when a recognizable word has been input, the neural network may only recognize that word when most or all of the feature vectors representing the word are sequentially input to the neural network 240. For example, every word has a duration, and a word may be recognizable only when feature vectors corresponding to all or a substantial portion of the duration are available. Any processing performed by the neural network 240 before most or all of the feature vectors representing a word are available in the neural network may be unproductive. Similarly, processing performed while the feature vectors representing a particular word are being replaced by new feature vector representing a subsequent word may also be unproductive. In either event, unproductive processing results in unnecessary and undesirable power consumption.

In the speech recognition system 200, the neural network 240 must be sufficiently fast to complete the speech recognition processing of each feature vector in the frame offset interval or time between receipt of one feature vector and the receipt of the subsequent feature vector by the neural network. For example, frame offset interval is 10 ms in systems conforming to the ES 201 108 standard. Assuming the neural network is implemented by software instructions executed by one or more processors, the aggregate processor speed must be sufficient to evaluate the characteristic equations, such as equation 001 above, for all of the neurons in the neural network. Each frame offset interval, the neural network 240 may need to process several hundred to several thousand vector elements from the feature vector 225 and evaluate the characteristic equations for hundreds or thousands of neurons. The required processing speed of the neural network 240 may be substantial, and the power consumption of the neural network 240 can be problematic or unacceptable for portable devices with limited battery capacity.

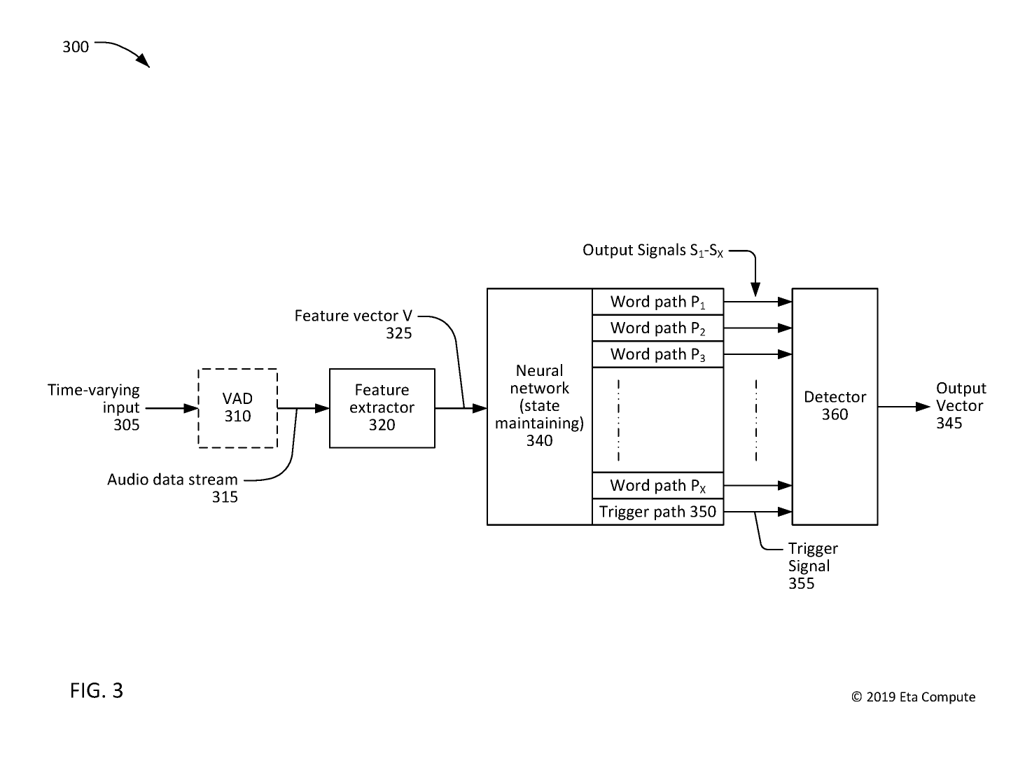

FIG. 3 is a functional block diagram of an improved continuous ASR system 300 including an optional voice activity detector (VAD) 310, an optional feature extractor 320, a neural network 340 including a trigger neural network path 350, and a detector 360. System 300 may be a continuous speech recognition system using a trigger neural path 350 of the neural network 340 to control when the detector 360 reviews the outputs of word neural paths P₁-P_{X} of neural network 340. Each of word paths P₁-P_{X} and trigger path 350 may be a neural path having a number of linked neurons including all neurons of an input rank of neurons that receive feature vectors from the extractor 320, a neuron of an output rank that generates the output signal (e.g., an output signal of one of word output signals S₁-S_{X} and trigger output signal 355), and one or more neuron of one or more intermediate or “hidden” ranks between the input rank and the output rank neuron. In some cases, for each neural path, the neurons of the input rank may be the same; the neurons of the intermediate ranks may be the same or different; and the neuron of the output rank will be different. The VAD 310 and the feature extractor 320 may be similar or identical to the corresponding elements 210 and 220 of the ASR system 200 of FIG. 2. Descriptions of these functional elements will not be repeated.

The signal 305 may be similar to the corresponding signal 205, although the signal 305 may have a duration of a long period of time during which the system 300 will be able to continuously perform ASR to detect in the vectors 345 the words of the limited vocabulary that exist in the signal 305 over the long period of time. It is possible that there may be numerous, a dozen or zero words of the limited vocabulary existing in signal 305 during the long period of time. The number of words of the limited vocabulary in the signal 305 may exist (e.g., be spoken or uttered) during shorter periods of time, such as one or a few minutes, while the signal 305 contains none of the words of the limited vocabulary during the rest of the long time. The longer period of time may be multiple days, multiple months or many years. The longer period of time may be between multiple days and multiple months. It is understood that system 300 may also operate for shorter periods of time such as for a few seconds or minutes if desired. Thus, during the long period of time, the neural network 340 performs speech recognition processing of the content of each of the consecutive feature vectors over a frame offset time of each feature vector V 325. Each feature vector V contains a representation of the input signal during a corresponding frame offset time (e.g., a time frame) and may or may not include one word of set of words W₁-W_{X}. The neural network 340 may be a state-maintaining network that controls the detector 360 based on current feature vector V input and, to at least some extent, one or more previous states of the neural network 340. For example, the neural network 340 may be an echo state network or some other type of recurrent neural network. Within the neural network, at least some neurons save respective prior states. The saved prior states are provided as inputs to at least some neurons.

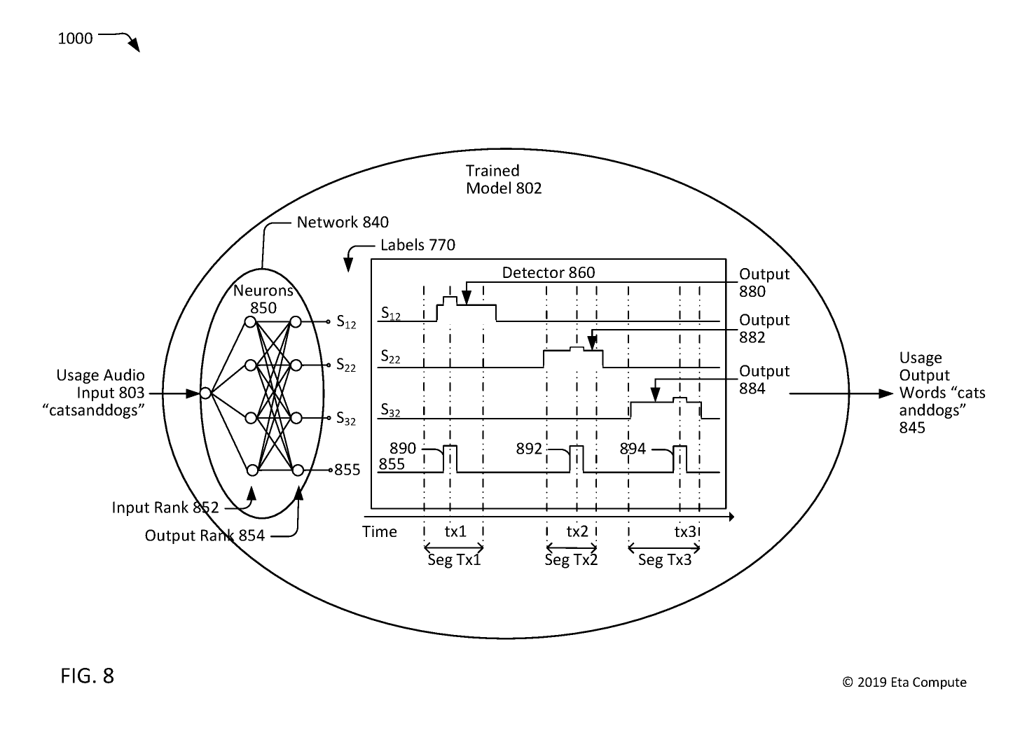

The neural network 340 may be a “deep” neural network divided into multiple ranks of neurons including an input rank of neurons that receive feature vectors from the extractor 320, an output rank that generates the word output signals S₁-S_{X} and trigger output signal 355, and one or more intermediate or “hidden” ranks. For example, the neural network 340 may be an SM neural network such as a recurrent neural network, a long short-term memory network, an echo state network (ESN) or a time-delay neural network similar to those types currently used for picture and speech recognition. The number of hidden ranks and the number of neurons per rank in the neural network 340 depend, to some extent, on the number of words X in the set of words of the vocabulary to be recognized. Typically, during the long period of time, each input to the neural network 340 receives sequences of the feature vectors V of frames from the extractor 320. For example, each of the feature vectors V received by the neural network 340 are input to input rank neurons of all of word paths P₁-P_{X} and trigger path 350 (e.g., see input rank 852 of FIG. 8) of the neural network 340 which outputs from the output rank neurons (e.g., see output rank 854 of FIG. 8), each word output signal S₁-S_{X} and trigger output signal 355 to detector 360, respectively, during the long period of time. In some cases, the trigger path 350 and word paths P₁-P_{X} of the neural network 340 share input rank neurons and one or more intermediate rank neurons. Each of word paths P₁-P_{X} and trigger path 350 may be a neural path of the neural network 340.

The neural network 340 may be designed and trained using known methods so that each output signal S₁-S_{X} has a greater amplitude and/or greatest energy when the word of the set of words W₁-W_{X} of the vocabulary is the word for that word path P₁-P_{X}. For example, the output signal corresponding to the word for that path will have a greater amplitude than when it the word is not the word for that path and/or will have a greatest energy as compared to the other output signals that do not correspond to that word. The neural network 340 may be designed and trained using known methods so that the output trigger signal 355 has a greater amplitude and/or greater energy when any word of the vocabulary is a word for any word path P₁-P_{X}. The signal 355 is greater when the word of is a word of the set of words W₁-W_{X} of the vocabulary than when the word or input is for a word that is not in the set of words W₁-W_{X}.

In some cases, the neural network 340 may be similar to, the neural network 240 in the ASR system 200 of FIG. 2, except that network 340 also includes the trigger path 350 which controls the detector 360. The path 350 outputs trigger signal 355 to the detector 360 during the long period of time to control when the detector reviews the output signals S₁-S_{X} to recognize the word and output that word as output vector 345.

When the trigger path 350 of an SM neural network is used to perform speech recognition processing, the output of the trigger path 350 depends on the present inputs to the network with consideration of the previous time history of those inputs. Thus, for an SM neural network to recognize a word captured in a series of feature vectors, a significant portion of the feature vectors that capture the word and a consideration of the prior inputs usually should be available to the trigger path 350 concurrently.

The ASR system 300 includes the trigger path 350 to perform speech recognition processing of a current frame of the consecutive feature vectors received from the feature extractor 320 during the long period of time. A new feature vector is processed by the trigger path 350 every frame offset interval. That is, the feature vectors of each frame will be sequentially available as inputs to the trigger path 350.

The trigger path 350 performs trigger processing of the content of the consecutive feature vectors of vectors 325. The trigger path 350 is configured to determine when during the long period of time, the detector 360 should perform the speech recognition processing on the output signals S₁-S_{X} to attempt to recognize a word by triggering when the detector 360 reviews the output signals S₁-S_{X} to recognize the word and output that word as output vector 345. To this end, the trigger path 350 receives the stream of feature vectors 325 from the feature extractor 320 and determines when the stream of feature vectors represents, or is likely to represent, a recognizable word during the long period of time. The trigger path 350 outputs the trigger signal 355 which may be one or more commands 355 to cause the detector 360 to review the output signals S₁-S_{X} to recognize the word from the set of words W₁-W_{X} and output that word as output vector 345 only when the vector memory contains a sufficient number of feature vectors representing (or likely to represent) a recognizable word. At other times, the detector 360 remains in a low power quiescent state. The detector 360 does not perform speech recognition processing when it is in the quiescent state. Operating the detector 360 on as “as-needed” basis results in a significant reduction in power consumption compared to the speech recognition system 200 where the detector 260 reviews the output signals S₁-S_{X} to recognize the word every frame offset interval.

The trigger path 350 provides one or more commands in the trigger signal 355 to the detector 360. When the elements of the ASR system 300 are implemented in hardware, the trigger path 350 may provide the trigger signal 355 in the form of control signals to the detector 360. When the detector 360, trigger path 350 and neural network 340 are implemented using software executed by the same or different processors, the trigger path 350 may issue the trigger signal 355 by setting a flag, generating an interrupt, making a program call, or some other method.

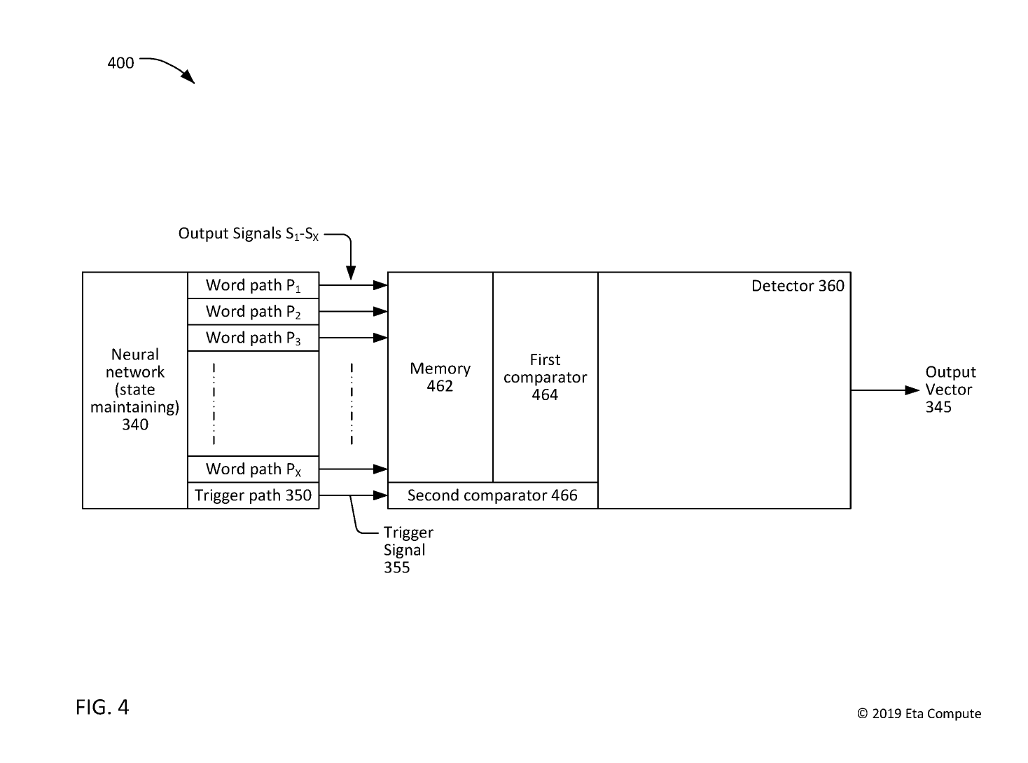

FIG. 4 is a functional block diagram of the improved continuous ASR system 300 of FIG. 3 showing details of detector 360. System 300 may use the trigger neural path 350 of the neural network 340 to output trigger signal 355 to the detector 360 to control when the detector reviews the output signals S₁-S_{X} to recognize the word of the set W₁-W_{X} and output that word as output vector 345 during long periods of time.

In some cases, the trigger neural path 350 is configured to send a review command to the detector 360 in signal 355 during the long period of time. The review command causes the detector to review the output signals S₁-S_{X} for a strongest (e.g., greatest) value output signal, and recognize the word of the plurality of words W₁-W_{X} by detecting the output signal having a strongest signal value during a period of time related to a when the review command is received. For example, the review command may be used to indicate the beginning or end of the strongest signal of output signals S₁-S_{X} and/or of an utterance of the word input as signal 305. The value of the output signal may be a maximum analog or digital amplitude or energy level of the output signal over the time period. In some cases, the value is the sum of that level over the time period, such as the integral of the signal over the time period. In some cases, the value is the derivative of the signal over the time period.

In FIG. 4, the detector 360 is shown having memory 462 to receive and store the output signals S₁-S_{X}, a first comparator 464 to compare the stored output signals and a second comparator 466 to compare the trigger signal 355. For instance, memory 462 may be a word memory hardware or software to store (e.g., buffer) the output signals S₁-S_{X} received for a temporary period of time such as for a frame length. Optionally, the memory 462 may also save signal 355 received for the period of time. The first comparator 464 may be a hardware or software word comparator to compare each value of each stored output signal for the period of time to one of a first threshold or each other value of the stored output signals. The first threshold may be 60 percent, 75 percent or 90 percent of the maximum output signal amplitude or energy expected for each word output signal. It may be different for each word path output. The second comparator 466 may be a hardware or software trigger comparator to compare a value of the trigger signal for the period of time to a second threshold. The second threshold may be 60 percent, 75 percent or 90 percent of the maximum output signal amplitude or energy expected for the trigger output signal. It may be different for each word of the word path outputs. When second comparator 466 detects that the value of the trigger signal for the period of time exceeds the second threshold, the detector causes first comparator 464 to compare each value of each stored output signal for the period of time to determine which stored signal exceeds the first threshold or has the greatest value. The stored signal that exceeds the first threshold or has the greatest value can be output as the output vector 345 to indicate the detected speech word. The period of time of the comparison by first comparator 464 may be before, during or after when the trigger signal exceeds the first threshold or when a review command is received in signal 355.

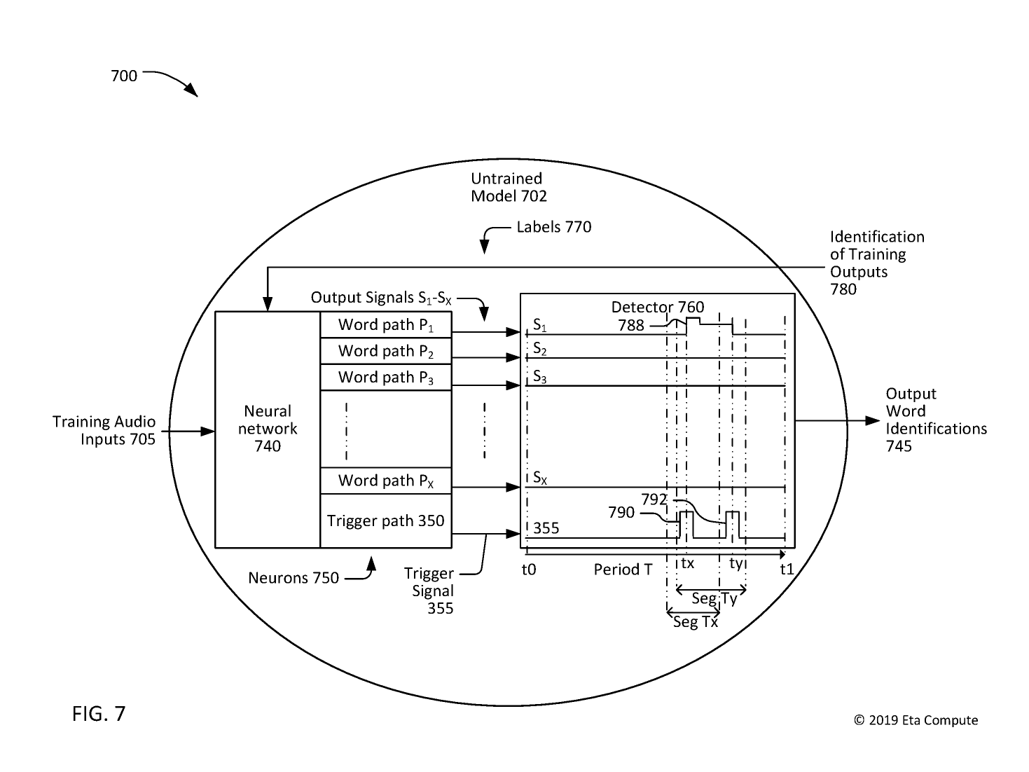

In some cases, the neural network 340 has a plurality of neurons of each word path P₁-P_{X} having weights based on training, to output a greatest value (e.g., greatest energy) signal on one word path (a different one for each word) and a lower signal value on the other word paths for each of the set of words W₁-W_{X}. In some cases, the neural network 340 has a plurality of neurons of trigger path 350 having weights based on training, to output a greatest value signal for each of the set of words W₁-W_{X}. See neurons of FIGS. 7-8 for simplified examples.

Consequently, system 300 as shown in FIGS. 3-4 can be continuously receiving input 305, continuously inputting vectors 325 into the network 340 (such as during times when VAD is outputting stream 315), continuously outputting the output word signals and trigger signals for numerous words, continuously detecting which word path has the strongest signal during a time related to when each trigger signal is received, and continuously outputting a vector 345 for each of the detected words (e.g., the words corresponding to the word paths having the strongest signals during the related times). Notably, each of the above functions may be occurring in a pipeline type atmosphere where each continuous function is operating on data previously processed by the prior continuous function, such as where while the vectors 325 of one frame are being created, the vectors for the prior frame are being processed by the network 340, while the output word signals and trigger signals of the two frames before are being reviewed by the detector 360 and the word from three frames before is being output by vector 345.

System 300 may be a system for continuous automatic speech segmentation and recognition. Segmentation may be when network 340 uses trigger signal 355 to allow the detector to identify small segments of time related to when the detector should search the word output signals for a word. Recognition may be the detector monitoring the trigger signal for the review commands and using those commands to review the word output signals to detect the words.

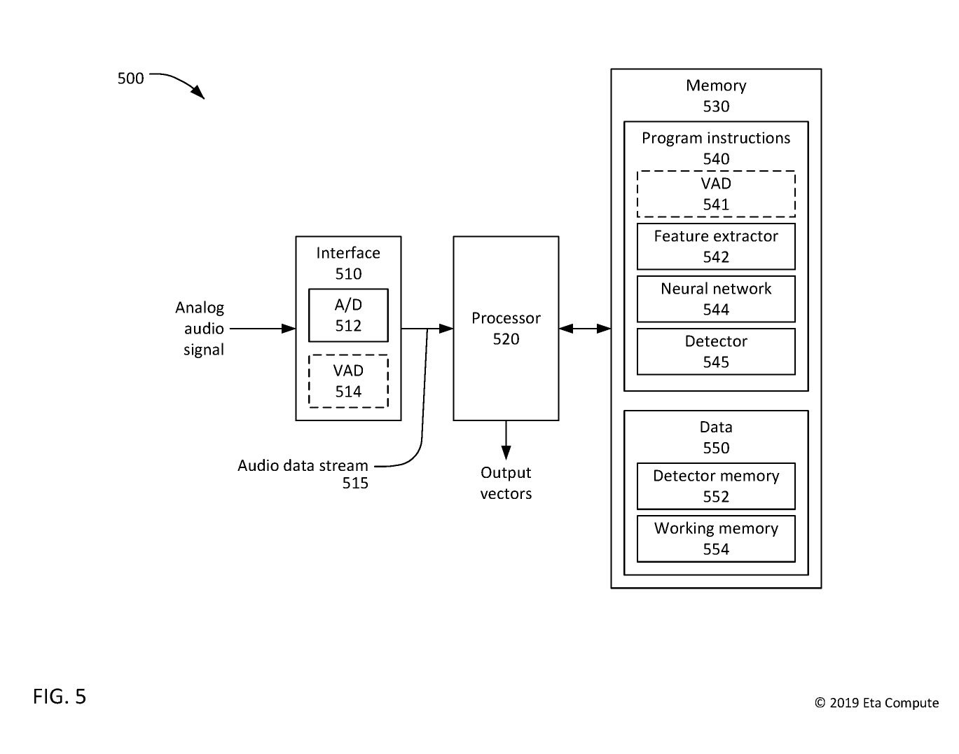

FIG. 5 is a block diagram of a continuous ASR system 500 in which a neural network having a trigger path to control when a detector performs speech recognition are implemented by software executed by one or more processing devices. The ASR system 500 may be the ASR system 300 of FIG. 3; the ASR system of FIG. 4; and/or the model 702, 802 of FIGS. 7-8. The ASR system 500 includes an interface 510, a processor 520 and a memory 530. In this context, a “processor” is a set of digital circuits that executes stored instructions to perform some function. A “memory” is a device for storing digital information such as data and program instructions. The term “memory” encompasses volatile memory such as semiconductor random access memory. The term “memory” also encompasses nonvolatile memory such as semiconductor read-only memory and flash memory and storage devices that store data on storage media such as magnetic and optical discs. The term “storage media” means a physical object for storing data and specifically excludes transitory media such as signals and propagating waves.

Assuming the input to the ASR system 500 is an analog signal from a microphone, such as signal 205, 305, 705 or 803. The interface 510 includes an analog to digital converter (A/D) 512 to output an audio data stream 515 and, optionally, a voice activity detector 514 implemented in analog or digital hardware.

The processor 520 executes instructions stored in the memory 530 to perform the functions of the feature extractor, neural network and detector, and (optionally) voice activity detector of the ASR system 500. The processor 520 may include one or more processing devices, such as microprocessors, digital signal processors, graphics processors, programmable gate arrays, application specific circuits, and other types of processing devices. Each processing device may execute stored instructions to perform all or part of one or more of the functions of the ASR system 500. Each function of the ASR system 500 may be performed by a single processing device or may be divided between two or more processing devices.

To realize the reduction in power consumption possible with this ASR system architecture, the processing device or devices that implement the detector 360 can be capable of transitioning between an active mode and a low (or zero) power quiescent mode. The processing device or devices that implement the detector may be placed in the quiescent mode except when performing speech recognition processing or reviewing the output signals of the neural network under control of the trigger neural path or signal. When a single processing device implements more than one function of the ASR system, the processing device may be in an active mode for a portion of each frame and a quiescent mode during another portion of each frame offset interval.

For example, in the case where a single processing device implements all of the functions of the ASR system, a small time interval at the start of each frame offset interval may be dedicated to the VAD function. When the VAD function determines the input data includes voice activity, a time interval immediately following the VAD function may be used to implement the feature extract function. An additional time interval (which may be a majority of the frame offset interval) may be used to implement the neural network 340, 740 or 840. The remaining time may be reserved to implement the detector 360, 760 or 860. The processor may be in its quiescent state during the time reserved for implementing the detector except when performing speech recognition processing or reviewing the output signals from the neural network to recognize a word in response to a trigger signal or review command provided by the neural network. In some cases, processor may be in its quiescent state during the time reserved for implementing the detector to monitor the trigger signal for the review command and in its active state when reviewing the word output signals from the neural network to recognize a word in response to the trigger signal or review command.

The memory 530 stores both program instructions 540 and data 550. The stored program instructions 540 include instructions that, when executed by the processor 520, cause the processor 520 to implement the various function of the continuous ASR system 500. The stored program instructions 540 may include instructions 541 for the voice activity detector (VAD) function if that function is not implemented within the interface 510. The stored program instructions 540 include instructions 542 for the feature extractor function; instructions 544 for the neural network 340, 740 or 840 function (including those for trigger path 350); and instructions 545 for the detector 360, 760 or 860 function.

Data 550 stored in the memory 530 includes a detector memory 552 to store (e.g., buffer) output signals S₁-S_{X} (and optionally the signal 355), and a working memory 554 to store other data including intermediate results of the various functions. Memory 552 may be memory 462.

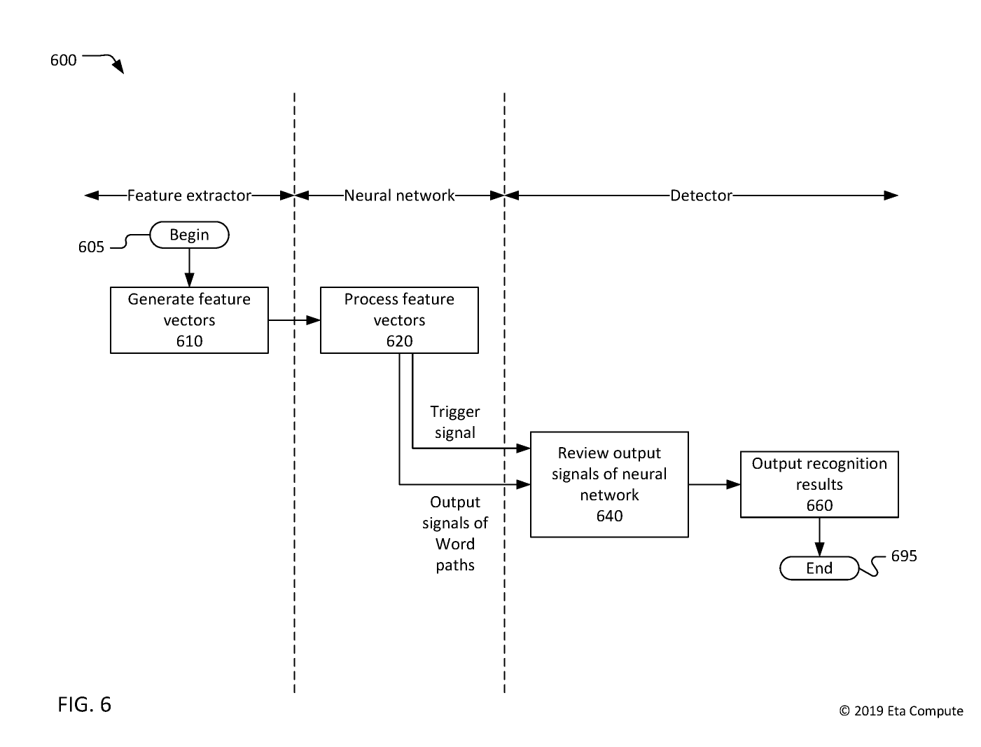

FIG. 6 is a flow chart of a process 600 for continuously recognizing words of a limited vocabulary using a continuous ASR system. The process 600 may be performed by a continuous ASR system including a feature extractor, a neural network and a detector as described herein. The ASR system may be the ASR system 300, the ASR system of FIG. 4, model 702 and/or model 802 (e.g., see FIG. 8).

The process 600 begins at 605. The process may begin at 605 in response to beginning to receive an input signal such as input signal 305, 703 or 803 that includes a human voice (though other voices may be considered, such as a bird, cat or dog). In other cases, the process may begin at 605 by virtue of a voice activity detector (not shown) indicating receipt of a human voice. The process 600 ends at 695 with the output of an output vectors for the limited vocabulary words detected in the input signal. The process 600 may continuously recognize words of a series or set of words (e.g., see FIG. 8). Process 600 may be a process for continuous automatic speech segmentation and recognition, such used by a continuous ASR described herein.

At 610, the feature extractor partitions the input signal into a sequence of frames and generates a corresponding sequence of feature vectors, each of which represents the input signal content during the corresponding frame. Every frame offset interval, a new feature vector is generated at 610.

At 620 the neural network processes each new feature vector from 610 to determine whether or not the sequence of feature vectors represents a recognizable word (e.g. a word from the vocabulary of the ASR system). At 620 the processing includes processing by the word paths and by the trigger path of the neural network to output the output signals of the word paths and the review signal from the trigger path. When the trigger path determines that the sequence of feature vectors contains, or is likely to contain, a recognizable word, the neural network issues trigger signal with a review command that cause the detector to start reviewing (e.g., the stored) output signals of the word paths of the neural network at 640.

Processing at 620 may include processing, in a neural network, feature vectors sequentially extracted from an audio data stream to attempt to recognize a word from a set of words of a predetermined vocabulary. It may then include outputting from the neural network, word output signals to a detector for each of the set of words; and outputting from the neural network trigger output signals or review commands to the detector to control when the detector reviews the word output signals to recognize the words.

Processing at 620 may include the neural network controlling when the detector reviews the word output signals by outputting the trigger output signal based on the sequentially extracted feature vectors; and holding the detector in a quiescent state except when performing the speech recognition detecting under control of the trigger neural path. Processing at 620 may include the neural network outputting the trigger output signal when a review of the word output signals determines that the sequentially extracted feature vectors are likely to represent a word from the set of vocabulary words. Processing at 620 may include the neural network storing data derived from the feature vectors in a plurality of neurons, some of which store one or more prior states, and receiving at the at least some of the plurality of neurons, as inputs, the one or more stored prior states. Processing at 620 may include the neural network sending review commands to the detector to cause the detector to review the word output signals for a greatest value output signal.

At 640, the detector reviews the output signals sent by the neural network at 620. This review may be to monitor the trigger signal to detect the review commands. When the detector receives each review command, it may begin reviewing (e.g., the stored) output signals of the word paths of the neural network to recognize the word. Reviewing at 640 may include the detector monitoring the trigger signal output for the review commands by detecting that the value of the trigger signal exceeds the second threshold; and recognizing the word of the plurality of words by detecting the word output signal having a greatest signal value during a period of time related to a when each review command is received. Reviewing at 640 may include the detector storing the word output signals; and comparing each value of each stored word output signal for the related period of time to a first threshold or each other value to detect the greatest signal value. The related period of time may be before, during or after when the review command is received.

The word output signal having the greatest signal value may have a greatest amplitude or energy peak at a point in time or for a segment of time during the period of time related to a when the review command is received. The greatest signal value may be the greatest amplitude or the greatest energy for a segment of time (e.g., the sum or integral over the segment of time) that is related (e.g., after, during or before) to when the review command is received such as describe for FIGS. 7-8 (e.g., time tx or tx; or segment Tx or Ty).

At 640 the detector may be in its quiescent state except when it is reviewing the word output signals from the neural network. Here, the detector may be in its quiescent state during the time it is monitoring the trigger signal from the neural network for the review command and in its active state when reviewing the word output signals from the neural network to recognize a word in response to detecting the review command.

After the detector recognizes the word of the plurality of words having a greatest signal value at 640, at 660 it outputs the results of the speech recognition processing on the content of the output signals by outputting output words or output vectors as recognition results. The process 600 then ends at 695 or may repeat, such as for a different input signal.

FIG. 7 is a block and timing diagram showing a training system 700 for training a model of a continuous ASR system that may be used for improved speech segmentation and recognition. The system 700 includes untrained artificial intelligent model 702 having neural network 740 and detector 760. The network 740 may be the network 340. In some cases, the network 740 is the VAD 310, the extractor 320 and the network 340. The detector 760 may be the detector 360. Within the detector 760, the diagram 700 also shows the timing diagram for the signals of labels 770 received, monitored and reviewed by detector 760.

The network 740 has neurons 750, such as neurons of a neural network which each receive the input signal 705 which “swishes around” neurons of such a network and provides outputs at labels 770. The input signal 705 may be a signal such as signal 205 or 305. The labels 770 may be word output signals S₁-S_{X} and trigger signal 355. The network 740 (e.g., neurons 750) and the detector 760 can be trained with training data such as training audio inputs 705 and identification of training outputs 780. Training outputs 780 train the network 740 to output the words corresponding to the inputs 705 as the desired one of word output signals S₁-S_{X} and output the review command on trigger signal 355 at the desired time to detect that word output signal. Thus, the output word identifications 745 may be output vectors such as vector 345 that corresponds to the words in inputs 705 (e.g., the desired ones of word output signals S₁-S_{X}).

Each of training audio input data 705 has an utterance of a known training word or term for a corresponding known identification of training outputs 780. That is, outputs 780 and input data 705 can be used to train the network 740 and detector 760 to know which of the word output signals S₁-S_{X} output by the word paths P₁-P_{X} of the network 740 based on the input data 705 is the correct one to choose as the known word of the corresponding input data 705. For example, each of training outputs 780 may be used to train the network 740 to output the greatest signal value on a specific one of the word output signals S₁-S_{X} and to train the detector 760 to know that that specific one of the output signals corresponds to the known one word of each known input data 705 which will thus be output as output words 745. The word output signal of signals S₁-S_{X} having the greatest signal value may have a greatest amplitude or energy peak at a point in time tx and ty of period T or for a segment of time Tx and Ty of period T during the period of time related to a when the review command 790 or 792 is received. The greatest signal value may be the greatest amplitude or the greatest energy for a segment of time Seg Tx or Seg Ty (e.g., the sum or integral over the segment of time) that is a time related to when the review command is received such as describe for FIG. 8. Any of time tx and ty; or segment of time Tx and Ty may be considered a period of time related to a when the review command is received.

Thus, the output word identified by the identification outputs 780 and input signals 705 train the untrained network 740 to provide a word output identification labels 745 that is a single label of word output signals S₁-S_{X} of labels 770 for the known word or term input at 705. The output words identified by the identification outputs 780 and input signals 705 also train the untrained detector 760 to detected that one signal having the greatest amplitude or energy of the word output signals S₁-S_{X} of labels 770 over a known period of time, which thus will used to identify that term as output identification 745 in the trained model when the word is part of a usage audio input.

In addition, the outputs 780 and input data 705 can be used to train the network 740 and detector 760 to know when to review the word output signals S₁-S_{X} output by the word paths P₁-Pₓ of the network 740 based on the input data 705 for the known word of the corresponding input data 705. For example, each of training outputs 780 may be used to train the network 740 to output a greatest signal value (e.g., a review signal) 790 or 792 as the trigger output signal 355 and to train the detector 760 to know when to review the word output signals S₁-S_{X} for the specific one of the output signals S₁-S_{X} having the greatest signal value. The greatest signal value 790 and 792 for output signal 355 may have a greatest amplitude or energy peak at a point in time tx or ty or for a segment of time Tx or Ty during the period of time related to when the detector should review the output signals S₁-S_{X} for a word. In one case, the signal value is at tx is the review command 790 and is centered or begins at the same time as the beginning of the greatest amplitude or the greatest energy for the output signals S₁-S_{X} of a word such as shown for greatest signal 788 of signal S₁ that is related to the word for the input signal 705 being received. In another case, the signal value is at ty is the review command 792 and is centered or begins at the same time as the ending of the greatest amplitude or the greatest energy for the output signals S₁-S_{X} of a word such as shown for greatest signal 788 of signal S₁ that is related to the word for the input signal 705 being received. The trigger signal 355 may be trained to be tx at the beginning of the utterance of the word input at 705 (e.g., having greatest amplitude 788 or the greatest energy for the output signals S₁ of output signals S₁-S_{X}) or may be trained to be ty at the end of the utterance of the word input at 705 (e.g., having greatest amplitude 788 or the greatest energy for the output signals S₁ of output signals S₁-S_{X}).

Thus, the output words identified by the identification outputs 780 and input signals 705 train the untrained network 740 to provide a review command 790 or 792 in the trigger signal 355 for when to review the word output signals S₁-S_{X} to detect the known word or term input at 705. Thus, the detector 760 can continuously monitor the trigger signal 355 for the review command of labels 770 and determine when to review the continuous output signals in S₁ to S_{X}.

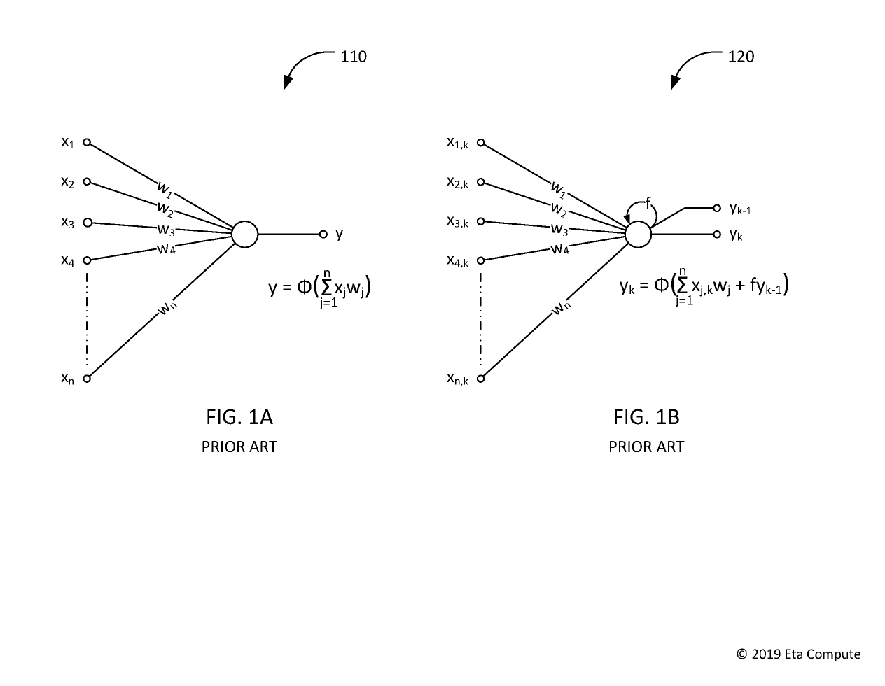

Each of labels 770 has a weighted output from each of neurons 750 of a word or the trigger path such as noted for output signals of the network 340. For example, after training of model 702, each of labels 770 of the trained model (e.g., see model 802 of FIG. 8) may be for a different word path P₁-P₃ (etc.) with neurons each having a (e.g., different) weight and/or output (e.g., see FIGS. 1A-B) as determined by or during the training process so that during use, these labels identify the terms in the trained model that were input at 705.

After training, label trigger 355 may be used for continuous speech segmentation and recognition, such as in system 300, the ASR system of FIG. 4, the ASR system 800. For example, label trigger 355 may output a signal that indicates a combination, such as an aggregate or other mathematical combination of the signals or parameters (e.g., energy) of the signals at each of neurons 750 in the trigger path 350 for inputs 705. In some cases, it may be the aggregate of one or more parameters of the unweighted outputs from each of neurons over time. In some examples, after training of model 702, label trigger 355 of trained model 802 may be for the trigger path 350 with neurons each having a (e.g., different) weight and/or output (e.g., see FIGS. 1A-B) as determined by or during the training process so that during use, label trigger 355 can output the review command during the a long period of time in the trained model 802 according to or for one or more of all of the terms that were input at 705.

In one case, label trigger 355 has evenly or equally weighted outputs of neurons 750 of trigger path 350. It is considered that label trigger 355 may be an addition of various feature vectors. In some cases, label trigger 355 may measure, represent or be an addition of various electrical signal parameters (analog and/or digital) from the input signal 705 (represented by neurons of path 350) including energy, amplitude, derivative, integral, phase, frequency, etc., such as over one or more frequencies or frequency ranges. In some case, such parameters are measured over an audio frequency range, for time t0-t1 for the utterance of each word input at input 705 for training as shown for detector 760 in the timing part of diagram 700.

The review commands 790 and 792 of training inputs 705 and 780 may be programmable parameters based on the trigger times and/or segments. For example, trigger times tx or ty, and/or related trigger segments Tx or Ty of time may be a review command. FIG. 7 show review commands 790 and 792 based on trigger times tx and ty. In some cases, either or both of commands 790 and/or 792 may be used. One or more different review commands based on related segments Tx and/or Ty may also be used. In some cases, only one review command is used.

For example, training inputs for marking the trigger label 355 may be selected to indicate a peak increase in energy of the combination of the neurons 750 of the path 350 at trigger time tx. The time tx may be selected to be centered at a point in time when the energy level or command 790 of the signal 355 is greater than a selected peak threshold (e.g., the second threshold noted for FIG. 4), such as identified at a point in time when the utterance of the word at inputs 705 is at its beginning. In some cases, during training, an input sets tx for label trigger 355, as a predetermined or selected time of the label that indicates a peak increase of energy across the audio frequency range for the word utterance of the word input at 702.

Also, training inputs for marking the trigger label 355 may be selected to indicate a peak drop off in energy of the combination of the neurons 750 of the path 350 at trigger time ty. The time ty may be selected to be centered at a point in time when the energy level or command 792 of the signal 355 is greater than a selected peak threshold (e.g., the second threshold noted for FIG. 4), such as identified at a point in time when the utterance of the word at inputs 705 is at its ending. In some cases, during training, an input sets ty for label trigger 355, as a predetermined or selected time of the label that indicates a peak drop off of energy across the audio frequency range for the word utterance of the word input at 803. In some cases, during training output of label trigger, ty is predetermined or selected at a time of the output to indicate an end of a word utterance for the word input at 705.

Other trigger time indications are considered for training label 355, such as trigger time at a peak energy a word; or for a most energy over a period of time (not necessarily a greatest peak).

The related trigger segments of time Tx and Ty may be programmable parameters. Related segment Tx of the trigger label 355 may be selected to indicate a peak energy increase energy segment of the combination of the neurons 750 of the path 350 around and/or after trigger time tx which is at the beginning of the utterance or energy 788. Related segment Ty of the trigger label 355 may be selected to indicate a peak energy decrease energy segment of the combination of the neurons 750 of the path 350 around and/or before trigger time ty which is at the end of the utterance or energy 788. Each may be selected to be a period of time extending behind and beyond each trigger point by a predetermined or selected amount of time. The selected amounts of time may depend on which word is input at 705 or the selection of output 780.

Other trigger segments are considered for training label trigger 355, such as a segment around a peak energy of word trigger; or around a most energy over a period of time (not necessarily a greatest peak).

Trigger label 355 may be used to indicate a time or segment of time during the period of time T for looking at the word labels S₁-S₃ of labels 770 to identify the word identified by the output at 780 during training. Subsequently, during use, trigger label 355 of a trained model (e.g., the trained model 802) may be used to indicate a trigger time or segment of time for looking at the word labels to identify at the output 845 the word in the input 803 in continuous outputs such as S₁ to S_{X}.

These techniques are greatly beneficial when improving speech segmentation and recognition for a multiple work segment, such as when words are run together in a continuous speech stream. For example, FIG. 8 is a block and timing diagram 800 related to using a trained model 802 of a continuous ASR system for improved continuous speech segmentation and recognition. The trained artificial intelligent model 802 has the neural network 840 with the trained neurons 850 and detector 860 which are a trained version of neural network 740 with the trained neurons 750 and detector 760, trained with training data 705 and 745. The input signal 803 may be a signal such as signal 205, 305 or 705.

Training model 702 with label trigger 355 may be used to create trained model 802 of FIG. 8 to indicate trigger times 855 in a continuous speech string during a long period of time, such as for trigger segments of time for all of the words used to train model 702 to create trained model 802. For example, FIG. 8 shows a limited situation of 3 word output signals S₁₂-S₃₂ and corresponding trigger segments of time tx₁₋₃ that match or correspond to the input words at 803 over a long period of time. The longer period of time may be thousands or millions of period T of FIG. 7; and/or multiple hours. Thus, during a long period of time, the label trigger 355 may indicate the related trigger times or trigger segments Tx₁₋₃ of input words at 803 that can be used to identify or detect the output amplitude and/or energy level measured or monitored from trained network 804 that has the greatest amplitude level or energy for input 803.

In FIG. 8, review commands 890, 892 and 894 (and trigger times tx₁₋₃) are shown centered around a maximum output amplitude and/or energy level of the output signals S₁₂-S₃₂, respectively. However, it is considered that the review commands 890, 892 and 894 (and trigger times tx₁₋₃) can be programmed to be located the beginning or end of the utterance or of output amplitudes and/or energy levels of the output signals S₁₂-S₃₂, such as by being at the beginning or end of greatest energy outputs 880, 882 and 884.

Thus, model 802 may perform continuous speech recognition by having the neural network 840 is always running, thus outputting signals S₁₂-S₃₂ which are moving up and down in amplitude or energy. However, detector 860 does not review the output signals until the trigger signal 855 sends a review command or goes high (e.g., at 890-894). When the trigger signal goes high, detector 860 reviews the output signals and detects the one with the maximum and amplitude or energy, thus declaring that one as the result in vector 845. Thus, the addition and training of the trigger signal 855 to indicate that a word was uttered (e.g., and when to review for it) and to use of signal 855 to sample the other signals S₁₂-S₃₂ to make a decision, allows the model 802 to be continuously powered on and continuously perform ASR.

FIG. 8 shows system with trained model 802 receiving usage input 803 of “catsanddogs”. Here, model 802 has been trained (see FIG. 7) with various terms including inputting audio of “cats” at 705 and for the outputs 780 selecting label S₁ of labels 770 to recognize the word as “cats”; and for trigger label 355 selecting at input 855 trigger time tx1 during the long period of time as trained trigger output review command 890 of trigger label 855. In some cases, this training includes, based on the peak energy for the sum of labels S₁, S₂ and S₃; and from tx1 for labels S₁, S₂ and S₃ selecting related trigger segment Tx1 as trained trigger output review command 890 of trigger label 855 for inspecting the peak energy for each of labels S₁, S₂ and S₃ to identify a greatest energy output 880 (S₁₂ here) as selected output 845 as the word “cats”.

Also, here, model 802 has been trained with inputting audio of “and” at 705 and for the outputs 780 selecting label S₂₂ of labels 770 to recognize the word as “and”; and for trigger label 355 selecting at input 855 trigger time tx2 during the long period of time as trained trigger output review command 892 of trigger label 855. In some cases, this training includes, based on the peak energy for the sum of labels S₁, S₂ and S₃; and from tx2 for labels S₁, S₂ and S₃ selecting related trigger segment Tx2 as trained trigger output review command 892 of trigger label 855 for inspecting the peak energy for each of labels S₁, S₂ and S₃ to identify a greatest energy output 882 (S₂₂ here) as selected output 845 as the word “and”.

Moreover, here, model 802 has been trained with inputting audio of “dogs” at 705 and for the outputs 780 selecting label S₃₂ of labels 770 to recognize the word as “dogs”; and for trigger label 355 selecting at input 855 trigger time tx3 during the long period of time as trained trigger output review command 894 of trigger label 855. In some cases, this training includes, based on the peak energy for the sum of labels S₁, S₂ and S₃; and from tx3 for labels S₁, S₂ and S₃ selecting related trigger segment Tx3 as trained trigger output review command 894 of trigger label 855 for inspecting the peak energy for each of labels S₁, S₂ and S₃ to identify a greatest energy output 882 (S₃₂ here) as selected output 845 as the word “dogs”.

As noted, it is considered that instead of training to output review commands 890-894 based on the peak energy of tx1, tx2 and tx3; beginning or end of word utterance energy (and corresponding segments) may be used.

In FIG. 8, when an input 803 causes label trigger 855 to exceed or activate trigger time tx1 in trained detector 860 in a continuous speech stream during a long period of time, model 802 will inspect the other labels, such as using segment Tx1 to find which label (Label S₁₂) identifies at output 845 the word “cats” input at input 803. Also, when an input 803 causes label trigger 855 to exceed or activate trigger time tx2 in trained detector 860 during the period of time T, model 802 will inspect the other labels, such as using segment Tx2 to find which label (Label S₂₂) identifies at output 845 the word “and” input at input 803. Next, when an input 803 causes label trigger 855 to exceed or activate trigger time tx3 in trained detector 860 in a continuous speech stream during a long period of time, model 802 will inspect the other labels, such as using segment Tx3 to find which label (Label S₃₂) identifies at output 845 the word “dogs” input at input 803. As seen at outputs 898 the result of outputs 845 over a long period of time, is identification of the run together words “catsanddogs.” It can be appreciated that many additional words of the limited vocabulary may also be detected during the long period of time. Any of time tx1, tx2 or tx3; or segment of time Tx1, Tx2 or Tx3 may be considered a period of time related to a when the review command 890, 892 or 894 are received.

The concepts of using the trigger path, signal and/or label, such a with respect to FIGS. 3-8, may be described as improved speech segmentation and recognition, for automatic speech recognition (ASR). They may also be described as continuous automatic speech segmentation and recognition for ASR since they provide the ability to segment a long period time for inputting a signal (e.g., inputs 305 or 803) for the selected vocabulary without continuous use of a detector (e.g., detector 360 or 860); and without detecting unwanted words since the system can be programed with only desired words as the selected vocabulary. For example, this longer period may be thousands or millions of period TT and/or multiple hours.

The neurons shown in FIG. 8 are a simple model. It is understood that more neurons and/or more complicated neuron connections can be used for the neurons (e.g., neurons of network 340, neurons 750 and/or neurons 850). In some cases, the network (e.g., network 340, network 740 and/or network 840) may be implemented in hardware (e.g., each neuron is a transistor); software (e.g., each neuron is represented in computer instructions that can be executed by a processor); or a combination of hardware and software.

Although the word path and trigger path output signals (e.g., output of labels 770) are shown as square waves or impulses, it can be appreciated that they may have other shapes such as analog signals with waveforms and noise that are not as close to zero or as square as shown, but exceed thresholds where indicated by the labeled times and time segments.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A continuous automatic speech segmentation and recognition (ASR) system, comprising:
a detector;
a neural network to perform speech recognition processing on feature vectors sequentially extracted from an audio data stream to attempt to recognize a word from a set of words of a predetermined vocabulary;
the neural network having word neural paths to each output a word output signal to the detector for each of the set of words; and
the neural network having a trigger neural path to output a trigger signal to the detector to control when the detector reviews the word output signals to recognize the word.

2. The system of claim 1, wherein the trigger neural path controls when the detector reviews the word output signals based on the sequentially extracted feature vectors; and
wherein the detector is held in a quiescent state except when performing the speech recognition detecting under control of the trigger neural path.

3. The system of claim 2, wherein the detector is in the quiescent state when it is monitoring the trigger signal from the neural network for the review command; and
wherein the detector is in an active state when it is reviewing the word output signals from the neural network to recognize a word in response to detecting the review command.

4. The system of claim 2, wherein the trigger neural path causes the detector to review the word output signals when the trigger neural path determines that the sequentially extracted feature vectors are likely to represent a word from the set of words.

5. The system of claim 2, wherein
the trigger neural path is configured to send a trigger signal having a review command to the detector to cause the detector to review the word output signals for a greatest signal value output signal, and
the detector to recognize the word of the plurality of words by detecting the word output signal having a greatest signal value during a period of time related to a when the review command is received.

6. The system of claim 5, wherein the detector includes:
a word memory to store the word output signals;
a word comparator to compare each value of each stored word output signal for the period of time to one of a first threshold or each other value;
a trigger comparator to compare a value of the trigger signal for the period of time to a second threshold; and
the period of time is one of before, during or after when the review command is received.

7. The system of claim 1, wherein the neural network comprises:
a plurality of neurons, wherein
at least some of the plurality of neurons store one or more prior states, and
at least some of the plurality of neurons receive, as inputs, one or more stored prior states.

8. The system of claim 1, wherein the neural network comprises:
a plurality of neurons of each word path having weights based on training to output a greatest signal value on one word path and a lower signal value on the other word paths for each of the set of words,
a plurality of neurons of the trigger path having weights based on training to output a greater signal value for each of the set of words than for words that are not in the set of words.

9. The system of claim 1, where the neural network is an echo state network.

10. A method for continuous automatic speech segmentation and recognition (ASR), comprising:
processing in a neural network, feature vectors sequentially extracted from an audio data stream to attempt to recognize a word from a set of words of a predetermined vocabulary;
outputting from the neural network respective word output signals to a detector for each of the set of words; and
outputting from the neural network a trigger output signal to the detector to control when the detector reviews the word output signals to recognize the word.

11. The method of claim 10, wherein outputting the trigger output signal comprises:
outputting the trigger signal based on the sequentially extracted feature vectors; and
holding the detector in a quiescent state except when performing the speech recognition detecting under control of the trigger neural path.

12. The system of claim 11, wherein the detector is in the quiescent state when it is monitoring the trigger signal from the neural network for the review command; and
wherein the detector is in an active state when it is reviewing the word output signals from the neural network to recognize a word in response to detecting the review command.

13. The method of claim 11, wherein outputting the trigger output signal comprises:
reviewing the word output signals to determine that the sequentially extracted feature vectors are likely to represent a word from the set of words.

14. The method of claim 11, wherein controlling when the detector reviews the word output signals to recognize the word comprises:
sending a trigger signal having a review command to the detector to cause the detector to review the word output signals for a greatest signal value output signal, and
the detector recognizing the word of the plurality of words by detecting the word output signal having a greatest signal value during a period of time related to a when the review command is received.

15. The method of claim 14, further comprising the detector reviewing the word output signals to recognize the word, comprising the detector:
storing the word output signals;
comparing each value of each stored word output signal for the period of time to one of a first threshold or each other value, the period of time being one of before, during or after when the review command is received; and
comparing a value of the trigger signal for the period of time to a second threshold.

16. The method of claim 10, wherein processing comprises:
storing data derived from the feature vectors in a plurality of neurons, wherein
at least some of the plurality of neurons store one or more prior states, and
receiving at the at least some of the plurality of neurons, as inputs, the one or more stored prior states.

17. The method of claim 9, wherein processing comprises:
processing data derived from the feature vectors in a plurality of neurons, wherein
the plurality of neurons form word paths that each have weights based on training to output a greatest signal value on one word path and a lower signal value on the other word paths for each of the set of words,
the plurality of neurons form a trigger path having weights based on training to output a greater signal value for each of the set of words than for words that are not in the set of words.
